(19) United States
(12) Patent Application Publication
(10) Pub. No.: US 2013/0258926 A1
(43) Pub. Date: Oct. 3, 2013

(54) APPARATUS AND METHOD FOR ADJUSTING TRANSMISSION POWER OF A TERMINAL IN A WIRELESS COMMUNICATION SYSTEM

(71) Applicant: FUJITSU LIMITED, Kawasaki-shi (JP)

(72) Inventor: Manabu OSAKADA, Yokohama (JP)

(73) Assignee: FUJITSU LIMITED, Kawasaki-shi (JP)

(21) Appl. No.: 13/779,047

(22) Filed: Feb. 27, 2013

(30) Foreign Application Priority Data
Mar. 30, 2012 (JP) 2012-083064

(51) Int. Cl. H04W 52/04

(52) U.S. Cl. CPC H04W 52/04
USPC 370/311

(57) ABSTRACT

A base-station receives, from the terminal, a data-amount value of transmission-data held in the terminal, and obtains a predicted division-count indicating a predicted number of frames to be used for transmitting the transmission-data, based on the data-amount value and the amount of bandwidth allocatable to the terminal. The base-station obtains a difference between target and measured reception qualities of data from the terminal, calculates an adjustment-count value indicating a number of times the terminal is to be requested to adjust transmission-power until the difference falls to or below a threshold, reduces the amount of bandwidth to be actually allocated to the terminal when the predicted division-count is smaller than the adjustment-count value, so that the transmission-data is transmitted using as many frames as the adjustment-count value, and transmits, to the terminal, an adjustment request indicating the reduced amount of bandwidth, before the terminal transmits each frame.

### CROSS-REFERENCE TO RELATED APPLICATION

This application is based upon and claims the benefit of priority of the prior Japanese Patent Application No. 2012-083064, filed on Mar. 30, 2012, the entire contents of which are incorporated herein by reference.

### FIELD

The embodiments discussed herein are related to apparatus and method for adjusting transmission power of a terminal in a wireless communication system.

### BACKGROUND

Upon receipt of a communication request from a terminal, a base station determines allocation of a frequency bandwidth that the terminal is able to use for transmission of transmission data, according to the amount of data to be transmitted from the terminal. The base station also evaluates the reception quality of a control signal received from the terminal by using, for example, a signal-to-interference ratio (SIR) and determines whether transmission power being used by the terminal for transmission to the base station is appropriate. When the transmission power is not appropriate, the base station requests the terminal to adjust the transmission power. When notifying the terminal of the allocated frequency bandwidth that is usable by the terminal for transmission of transmission data, the base station requests the terminal to adjust the transmission power thereof. The terminal adjusts the transmission power in response to the notification from the base station before transmitting transmission data.

In a known method as a related technology, cycles are set in which a base station apparatus requests a terminal to adjust its transmission power so that the base station apparatus is able to appropriately receive signals from the terminal.

Japanese Laid-open Patent Publication No. 2010-28776 is an example of related art.

### SUMMARY

According to an aspect of the invention, an apparatus for adjusting transmission power of a terminal wirelessly communicating with the apparatus is provided. The apparatus includes a radio frequency (RF) processing circuit and a control circuit. The radio frequency (RF) processing circuit receives, from the terminal, a communication request that includes a data amount value indicating an amount of transmission data held in the terminal. The control circuit obtains a predicted division count indicating a predicted number of frames to be used for transmitting the transmission data, based on the data amount value and a first bandwidth value indicating a predicted amount of bandwidth allocatable to the terminal, and obtains a first difference between a target value of reception quality of data to be received from the terminal and a measured value of reception quality of data that has been actually received from the terminal. The control circuit calculates an adjustment count value indicating a number of times the terminal is to be requested to adjust transmission power until the first difference falls to or below a threshold value, and reduces an second bandwidth value indicating an amount of bandwidth to be actually allocated to the terminal when the predicted division count is smaller than the adjustment count value, so that the transmission data is transmitted by using as many frames as the adjustment count value. The RF processing circuit transmits, to the terminal, an adjustment request for adjusting the transmission power of the terminal, together with the second bandwidth value, before the terminal transmits each of frames used for transmitting the transmission data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a method, according to an embodiment;

FIG. 2 is a diagram illustrating an example of a hardware configuration of a base station, according to an embodiment;

FIG. 3 is a diagram illustrating a configuration example of a base station, according to an embodiment;

FIG. 4 is a schematic diagram illustrating an example of channels used by a system in which a base station is employed;

FIG. 5 is a diagram illustrating an example of an adjustment amount table, according to an embodiment;

FIG. 6 is a diagram illustrating an example of a table stored by a retransmission deciding unit, according to an embodiment;

FIG. 7 is a diagram illustrating an example of a communication sequence, according to a first embodiment;

FIGS. 8A and 8B are diagrams each illustrating an example of information used for allocating resource blocks, according to an embodiment;

FIG. 9 is a diagram illustrating an example of an operational flowchart of a base station, according to a first embodiment;

FIG. 10 is a diagram illustrating an example of a table held by a resource block allocating unit, according to an embodiment;

FIG. 11 is a diagram illustrating an example of information used for allocating resource blocks, according to an embodiment;

FIG. 12 is a diagram illustrating an example of an operational flowchart of a base station, according to a second embodiment;

FIG. 13 is a diagram illustrating an example of an operational flowchart for calculating the number of adjustments for reception quality of a signal received from a terminal, according to an embodiment; and

FIG. 14 is a flowchart illustrating an example of another method of calculating the number of adjustments for reception quality of a signal received from a terminal, according to an embodiment.

### DESCRIPTION OF EMBODIMENTS

The method described above as the related technology is problematic in that when a terminal transmits only a small amount of transmission data in a situation in which the terminal communicates less frequently with a base station, it is difficult to adjust transmission power. For example, assume that all transmission data is contained in one frame transmitted from the terminal to the base station, then the base station may notify the terminal of allocation of a frequency bandwidth only once because the base station does not allocate any more frequency bandwidth for transmission of user data from the terminal after the base station has completed the reception of the transmission data. Since the base station requests the terminal to adjust its transmission power at the time of notifying the terminal of an allocated frequency bandwidth, if the base station does not notify the terminal of an allocated frequency bandwidth, the terminal is not requested to adjust its transmission power. Then, even if the transmission power of the terminal has not been appropriately adjusted, the base station fails to request the terminal to adjust its transmission power. Therefore, transmission power used by the terminal to transmit next and later data is highly likely to become inappropriate.

Although a method is devised in which the amount of adjustment calculated at the base station is periodically transmitted to the terminal to avoid the above situation, it is difficult for the base station to monitor the results of adjustments made by the terminal. Accordingly, even if the transmission power of the terminal has been appropriately adjusted, unwanted adjustment may continue.

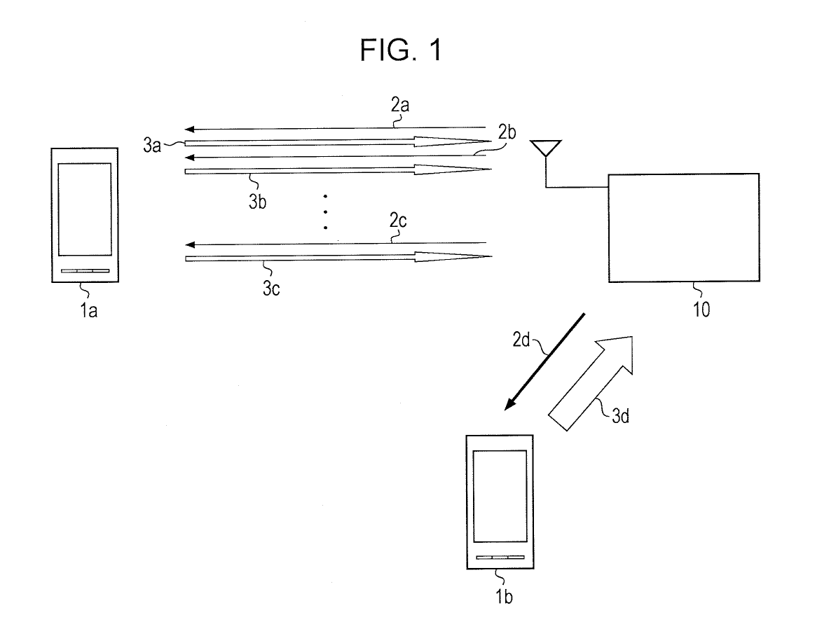

FIG. 1 is a schematic diagram illustrating an example of a method, according to an embodiment. The example in FIG. 1 assumes that a base station 10 has established communication with both a terminal 1a and a terminal 1b (both will be also referred to below as a terminal 1). In the description below, the term “resource block” will be used as a unit of allocation of a frequency bandwidth to a terminal. One resource block indicates a fixed length of continuous time for a fixed number of consecutive sub-carriers. For example, one resource block may be 0.5 continuous milliseconds for 12 consecutive sub-carriers.

After the base station 10 has established communication with the terminals 1a and 1b, the terminals 1a and 1b notify the base station 10 of the amount of transmission data to be transmitted. Upon receipt of a communication request from the terminal 1a, the base station 10 calculates a predicted number of frames used by the terminal 1a to transmit transmission data, based on the amount of transmission data to be transmitted from the terminal 1a and the number of resource blocks allocatable to the terminal 1a. Similarly, upon receipt of a communication request from the terminal 1b, the base station 10 calculates a predicted number of frames used by the terminal 1b to transmit transmission data, based on the amount of transmission data to be transmitted from the terminal 1b and the number of resource blocks allocatable to the terminal 1b. For simplicity, it is assumed that the terminals 1a and 1b are predicted to be able to transmit transmission data in one frame. In the description below, the term “predicted division count” will be also used as the predicted number of frames to be used for transmitting transmission data, and the term “predicted allocation count” will be also used as the number of resource blocks allocatable to a terminal. The base station 10 notifies the terminal 1 of a result of resource block allocation before each frame is transmitted. At that time, the base station 10 notifies the terminal 1 of a request to adjust transmission power together with the amount of adjustment to be made. Therefore, the predicted division count may be said as a predicted value of the number of times the base station 10 requests the terminal 1 to adjust the transmission power thereof.

In addition to obtaining the predicted division count for the terminal 1a, the base station 10 obtains, as a value of reception quality of a signal transmitted from the terminal 1, the SIR of a signal transmitted from the terminal 1a by using the reception power of the signal transmitted from the terminal 1a. The base station 10 stores in advance a target value of reception quality of signals to be transmitted from the terminals 1. The target value of the reception quality of signals to be transmitted from the terminal 1 will be also referred to below as the target SIR. The base station 10 also stores an amount by which transmission power is changeable by the terminal 1 in one adjustment in response to a request from the base station 10. The base station 10 obtains the number of transmission power adjustments (adjustment count) that are to be requested for the terminal 1a so that the SIR of the terminal 1a matches the target SIR, based on a difference between the SIR of the terminal 1a and the target SIR and the amount by which transmission power is changeable in one adjustment in response to a request.

The base station 10 compares the adjustment count obtained for the terminal 1a and the predicted division count obtained for the terminal 1a. When the adjustment count is larger than the predicted division count, the base station 10 determines that the transmission power of the terminal 1a will be inadequately adjusted because when transmission data is transmitted by using as many frames as the predicted division count, transmission of the transmission data is terminated before the terminal 1a completes the adjustment of transmission power thereof. Thus, the base station 10 changes the number of resource blocks to be allocated to the terminal 1a so that as many frames as the adjustment count are used to transmit the transmission data.

For example, when transmission power of the terminal 1a is too low, although the predicted division count obtained for the terminal 1a is 1, the adjustment count needed for causing the SIR of a signal obtained from the terminal 1a to match the target SIR is determined to be “10” to compensate for too low transmission power of the terminal 1a. Then, the base station 10 reduces the number of resource blocks to be allocated to the terminal 1a so that the terminal 1a uses 10 frames to transmit the transmission data. The base station 10 uses a control signal 2a to notify the terminal 1a of a result of allocating a changed number of resource blocks, a request for the terminal 1a to adjust its transmission power, and an amount by which the transmission power is to be adjusted. The terminal 1a adjusts the transmission power in response to the request from the base station 10, after which the terminal 1a uses the allocated resource blocks to transmit part of the transmission data to the base station 10. In FIG. 1, the transmitted frame is denoted by 3a.

Next, the base station 10 uses a control signal 2b to notify the terminal 1a of the result of allocating a changed number of resource blocks to the terminal 1a, a request to adjust its transmission power, and an amount by which adjustment is to be made. The terminal 1a adjusts its transmission power in response to the control signal 2b, after which the terminal 1a uses a frame 3b to transmit part of the transmission data to the base station 10. The base station 10 repeats similar processing until the base station 10 transmits a tenth control signal 2c to the terminal 1a. The terminal 1a adjusts the transmission power according to the control signal 2c, after which the terminal 1a stores part of the transmission data in a frame 3c and transmits the frame 3c to the base station 10. In this processing, after the adjustment according to the control signal 2c, the SIR of the signal transmitted from the terminal 1a to the base station 10 has been made close to the target SIR.

As for the terminal 1b, it is assumed that the predicted division count and the adjustment count are both 1. Then, the base station 10 determines that for the terminal 1b, the number of frames to be used to transmit transmission data is the same as the predicted division count. Then, the base station 10 uses a control signal 2d to notify the terminal 1b of a result of allocating resource blocks to the terminal 1b by using the predicted allocation count, a request to adjust its transmission power, and an amount by which the transmission power is to be adjusted. The terminal 1b adjusts its transmission power according to the control signal 2d, after which the terminal 1b stores part of the transmission data in a frame 3d and transmit the frame 3d.

As described above, when the reception state of a signal transmitted from the terminal 1 deviates from a target value, the base station 10 increases the number of frames to be used by the terminal 1 to transmit transmission data so as to provide the terminal 1 with a chance to adjust the transmission power thereof. Accordingly, even if the terminal 1 transmits only a small amount of transmission data, the base station 10 is operable to adjust the transmission power of the terminal 1 so that the target SIR is achieved. Furthermore, since the terminal 1 is notified of a request to adjust its transmission power together with a frequency bandwidth allocated for the terminal 1, when data transmission from the terminal 1 is terminated, the adjustment of the transmission power of the terminal 1 is also terminated. Therefore, the method according to the embodiment also suppresses too many adjustments from being made.

### First Embodiment

A first embodiment will be described with reference to the drawings. In the drawings, the terminal will be also described as UE (an abbreviation for “user equipment”) to comply with the identifier of the terminal which will be described later.

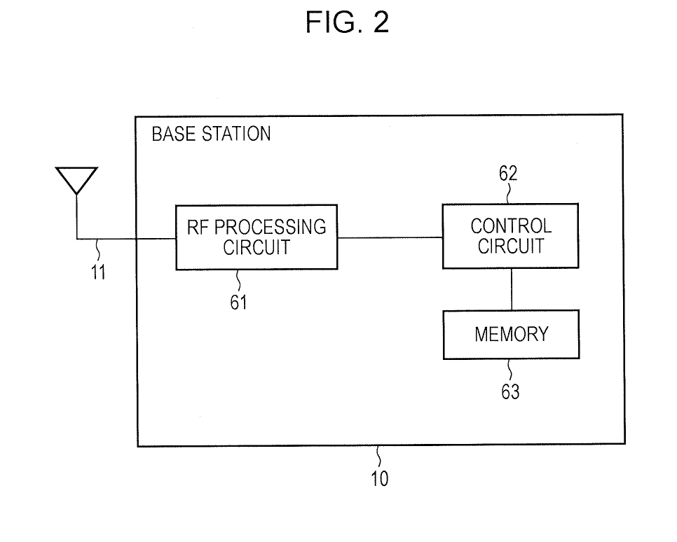

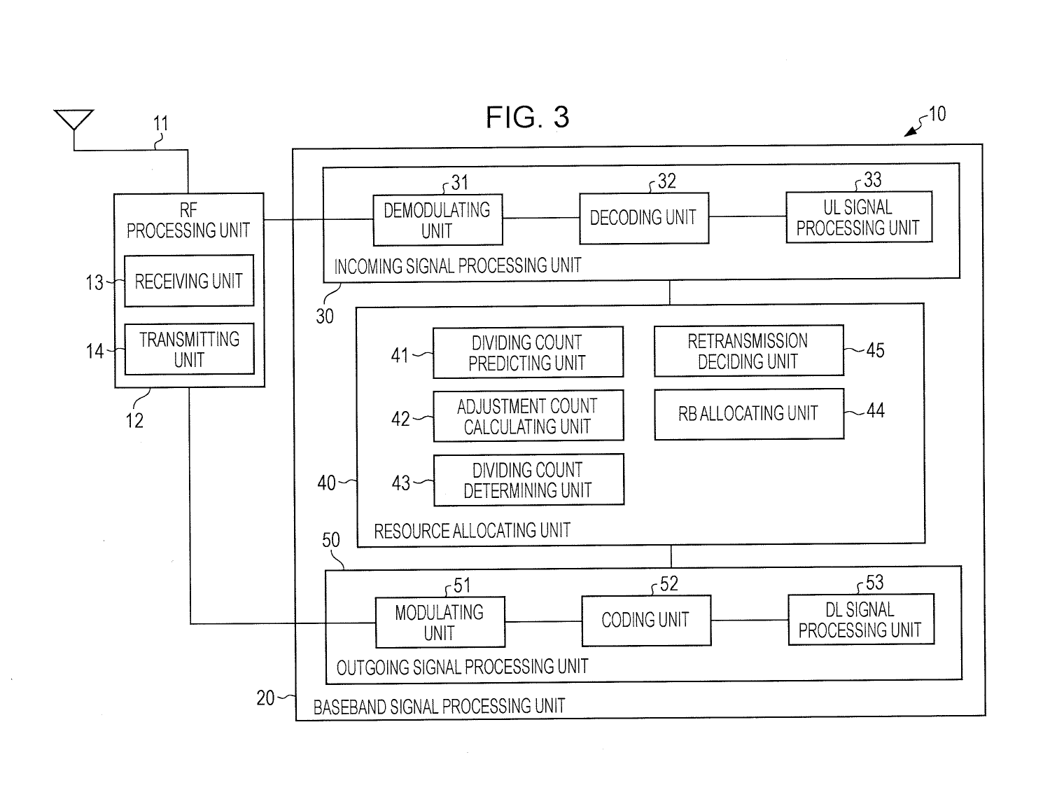

FIG. 2 is a diagram illustrating an example of a hardware configuration of a base station, according to an embodiment. The base station 10 includes an antenna 11, a radio frequency (RF) processing circuit 61, a control circuit 62, and a memory 63. An example of processing executed by using the RF processing circuit 61, control circuit 62, and memory 63 will be described with reference to FIG. 3.

FIG. 3 is a diagram illustrating a configuration example of a base station, according to an embodiment. The base station 10 may be configured to include an antenna 11, an RF processing unit 12, and a baseband signal processing unit 20. The RF processing circuit 61 of FIG. 2 functions as the RF processing unit 12, and processes carrier waves and amplitude signals. The control circuit 62 functions as the baseband signal processing unit 20. The memory 63 is used for processing by the baseband signal processing unit 20 at appropriate times.

The RF processing unit 12 includes a receiving unit 13 and a transmitting unit 14. The receiving unit 13 receives a signal transmitted from the terminal 1 via the antenna 11. In addition, the receiving unit 13 performs processing such as amplification of the received signal and removal of a carrier wave, and outputs the processed signal to the demodulating unit 31. The transmitting unit 14 receives a signal from a modulating unit 51, performs processing, such as amplification or multiplication with a carrier wave, on the received signal, and transmits the processed signal to the terminal 1.

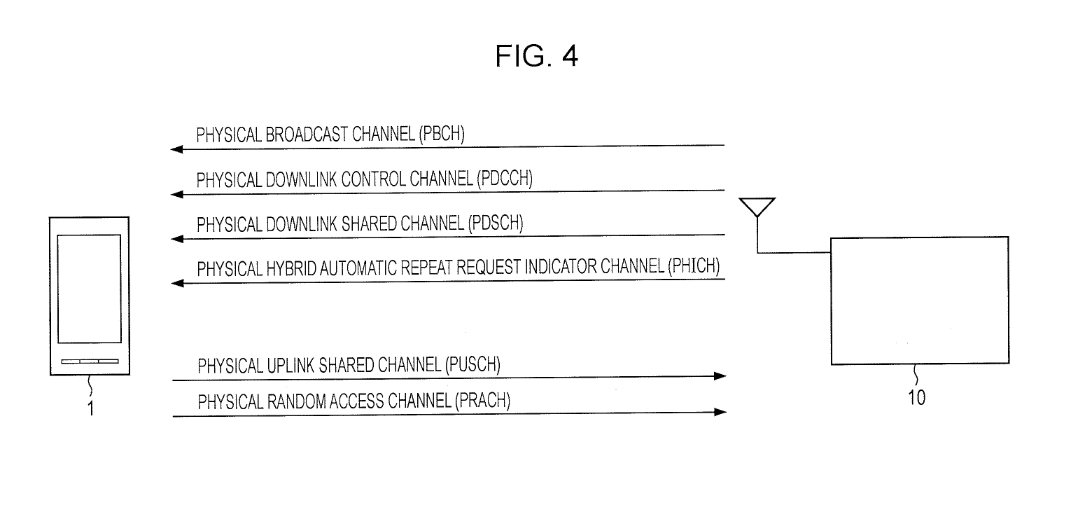

The baseband signal processing unit 20 includes an incoming signal processing unit 30, a resource allocating unit 40, and an outgoing signal processing unit 50. Examples of signal processing carried out by the incoming signal processing unit 30, resource allocating unit 40, and outgoing signal processing unit 50 will be described with reference to FIG. 4.

FIG. 4 is a schematic diagram illustrating an example of channels used by a system in which a base station is employed. The system in the example in FIG. 4 conforms to the Long Term Evolution (LTE) standard. Operations in the system will be described below in detail by taking the base station 10, which operates in the system conforming to the LTE standard, as an example.

The terminal 1 transmits a signal used for random access channel (RACH) processing, such as a communication request, through a physical random access channel (PRACH) channel to the base station 10. The terminal 1 also transmits transmission data to the base station 10 using the resource blocks that have been notified of from the base station 10. A frame including the transmission data is transmitted from the terminal 1 through a physical uplink shared channel (PUSCH) to the base station 10. The receiving unit 13 receives a signal through the PRACH or PUSCH, processes the received signal, and outputs the processed signal to the incoming signal processing unit 30.

The incoming signal processing unit 30 includes a demodulating unit 31, a decoding unit 32, and an uplink (UL) signal processing unit 33. The incoming signal processing unit 30 processes signals transmitted from the terminal 1 to the base station 10. The demodulating unit 31 receives a signal from the receiving unit 13, demodulates the received signal, and outputs the resulting signal to the decoding unit 32. The decoding unit 32 receives the signal from the demodulating unit 31, decodes the received signal, and outputs the decoded signal to the UL signal processing unit 33. The UL signal processing unit 33 receives the data from the decoding unit 32, appropriately processes the received data so that the received data is transferred to the communication destination of the terminal 1, and performs other processing.

The outgoing signal processing unit 50 includes a modulating unit 51, a coding unit 52, and a downlink (DL) signal processing unit 53. The outgoing signal processing unit 50 processes signals that are transmitted from the base station 10 to the terminal 1. The base station 10 is able to use a physical downlink control channel (PDCCH) and a physical hybrid automatic repeat request (ARQ) indicator channel (PHICH) to transmit signals to the terminal 1. The base station 10 transmits information about resource block allocation, the amount of transmission power to be adjusted by the terminal 1 and the like through the PDCCH to the terminal 1. The base station 10 notifies the terminal 1 through the PHICH whether data transmitted from the terminal 1 has been successfully received. When base station 10 transmits data to the terminal 1, a physical downlink shared channel (PDSCH) is used. Broadcast signals from the base station 10 are transmitted through a physical broadcast channel (PBCH).

The DL signal processing unit 53 processes control information and data that are transmitted through these channels, and creates baseband signals. The DL signal processing unit 53 outputs a baseband signal to the coding unit 52. The coding unit 52 receives the baseband signal and codes the received baseband signal by using a coding rate determined according to the quality of communication between the terminal 1 and the base station 10. The coding unit 52 then outputs the coded signal to the modulating unit 51. The modulating unit 51 receives the coded signal and modulates the received signal by a modulation method determined according to the quality of communication between the terminal 1 and the base station 10. The modulating unit 51 then outputs the modulated signal to the transmitting unit 14.

The resource allocating unit 40 allocates resource blocks to the terminal 1 in response to a communication request from the terminal 1. The resource allocating unit 40 has a dividing count predicting unit 41, an adjustment count calculating unit 42, a dividing count determining unit 43, a resource block (RB) allocating unit 44, and a retransmission deciding unit 45.

The dividing count predicting unit 41 obtains a predicted division count, based on the amount of data to be transmitted and a predicted allocation count. The dividing count predicting unit 41 then outputs the obtained predicted division count to the dividing count determining unit 43. An example of the operation of the dividing count predicting unit 41 will be described later.

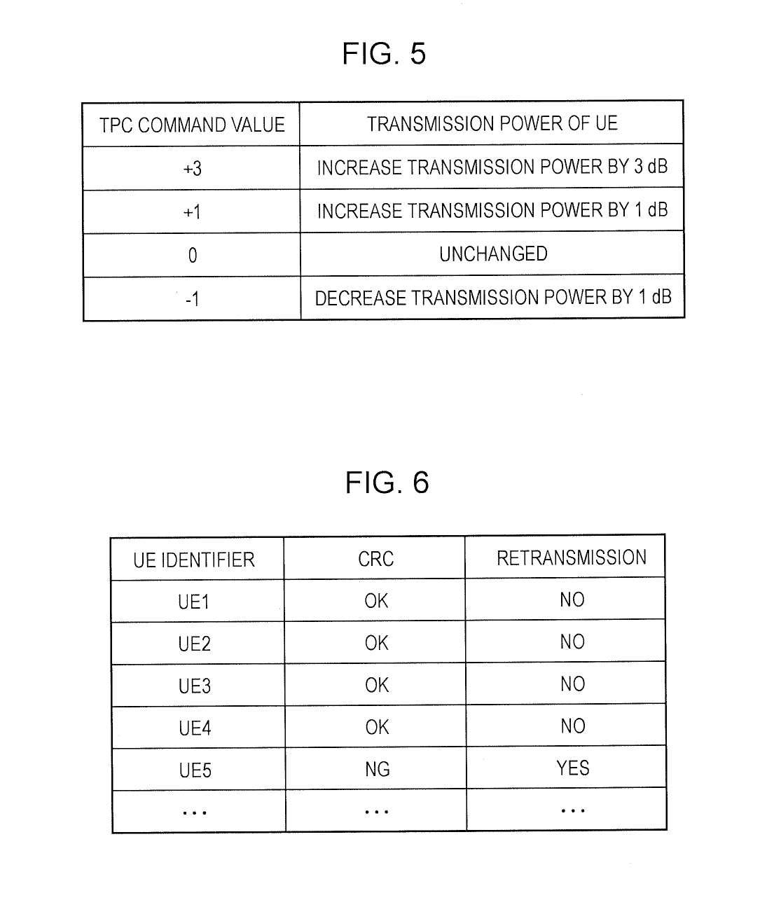

The adjustment count calculating unit 42 calculates the adjustment count. The adjustment count calculating unit 42 stores a value representing target quality in communication with the terminal 1. In the description below, an example in which communication quality is represented with an SIR will be taken. The adjustment count calculating unit 42 also stores the amount of transmission power that is able to be changed in one adjustment by the terminal 1. For example, the adjustment count calculating unit 42 may be configured to include an adjustment amount table as illustrated in FIG. 5. FIG. 5 illustrates an example in which a TPC command is used to transmit, from the base station 10 to the terminal 1, a notification of a request to adjust the amount of transmission power and the amount of adjustment. The adjustment count calculating unit 42 calculates the adjustment count by using the amount of adjustment of transmission power, and outputs the calculated value to the dividing count determining unit 43. The operation of the adjustment count calculating unit 42 will also be described later in detail.

The dividing count determining unit 43 determines the number of divisions (division count) based on the result of comparing the adjustment count and the predicted division count, where “division count” indicates the number of frames used to transmit transmission data. When the adjustment count is larger than the predicted division count, the dividing count determining unit 43 sets the division count at a value equal to the adjustment count. When the adjustment count is smaller than or equal to the predicted division count, the dividing count determining unit 43 sets the division count at the predicted division count. As for the terminal 1a illustrated in FIG. 1, for example, the adjustment count is 10 and the predicted division count is 1. Therefore, the dividing count determining unit 43 sets the division count at 10 for the terminal 1a in FIG. 1. As for the terminal 1b illustrated in FIG. 1, however, the adjustment count is 1 and the predicted division count is also 1. Therefore, the dividing count determining unit 43 sets the division count at 1 for the terminal 1b. The dividing count determining unit 43 outputs the determined division count to the RB allocating unit 44.

The RB allocating unit 44 determines the number of resource blocks to be allocated to the terminal 1, according to the division count determined by the dividing count determining unit 43, and allocates the determined number of resource blocks. The RB allocating unit 44 outputs a resource block allocation result to the DL signal processing unit 53. The DL signal processing unit 53 creates a notification message destined for the terminal 1. The notification message, which notifies the terminal 1 of the resource block allocation result, also includes an amount by which the terminal 1 is requested to adjust a transmission signal.

The retransmission deciding unit 45 checks the value of the cyclic redundancy check (CRC) of the frame received from the terminal 1 to determine whether the frame has been successfully received. When an error is detected in the CRC, the data is intended to be retransmitted. Accordingly, the retransmission deciding unit 45 determines an identifier identifying a terminal 1 that may retransmit the data, and stores the determined identifier.

FIG. 6 is a table illustrating an example of information stored by the retransmission deciding unit 45. In the example in FIG. 6, a CRC check result and a decision result as to whether to carry out retransmission are stored in association with a UE identifier identifying each terminal 1. In the example of FIG. 6, for UE1 to UE4, the value of the CRC in the received frame is normal (OK), and retransmission is not carried out. However, the value of the CRC of the frame storing data transmitted from UE5 is abnormal (NG), and retransmission is carried out. The retransmission deciding unit 45 performs processing for transmitting a retransmission request through the PHICH to the terminal 1 for which the value of the CRC is abnormal.

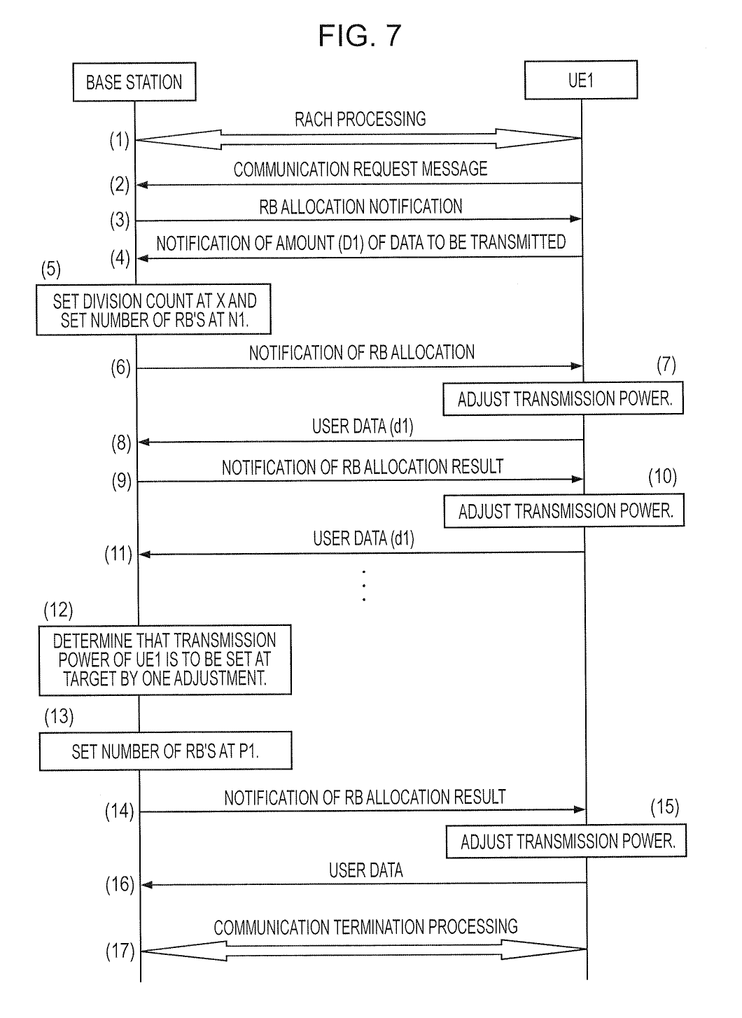

FIG. 7 is a sequence diagram illustrating an example of a communication method, according to a first embodiment. An example of operations executed in communication between the base station 10 and the terminal identified by the identifier UE1 will be described with reference to FIG. 7 (the terminal identified by the identifier UE1 will be sometimes simply referred to below as UE1). Numbers in a procedure described below correspond to the numbers depicted in FIG. 7. The description below assumes that TPC commands are used in transmission power adjustment.

(1) RACH processing is performed between the base station 10 and UE1 to establish communication.

(2) UE1 transmits a communication request message to the base station 10.

(3) Upon receipt of the communication request message, the base station 10 determines resource blocks that are used by UE1 to notify the base station 10 of the amount of transmission data to be transmitted and other information. The base station 10 then notifies UE1 of the determined resource blocks.

(4) UE1 notifies the base station 10 of the amount of transmission data to be transmitted, by using the notified resource blocks. The description below assumes the amount of transmission data transmitted by UE1 is D1.

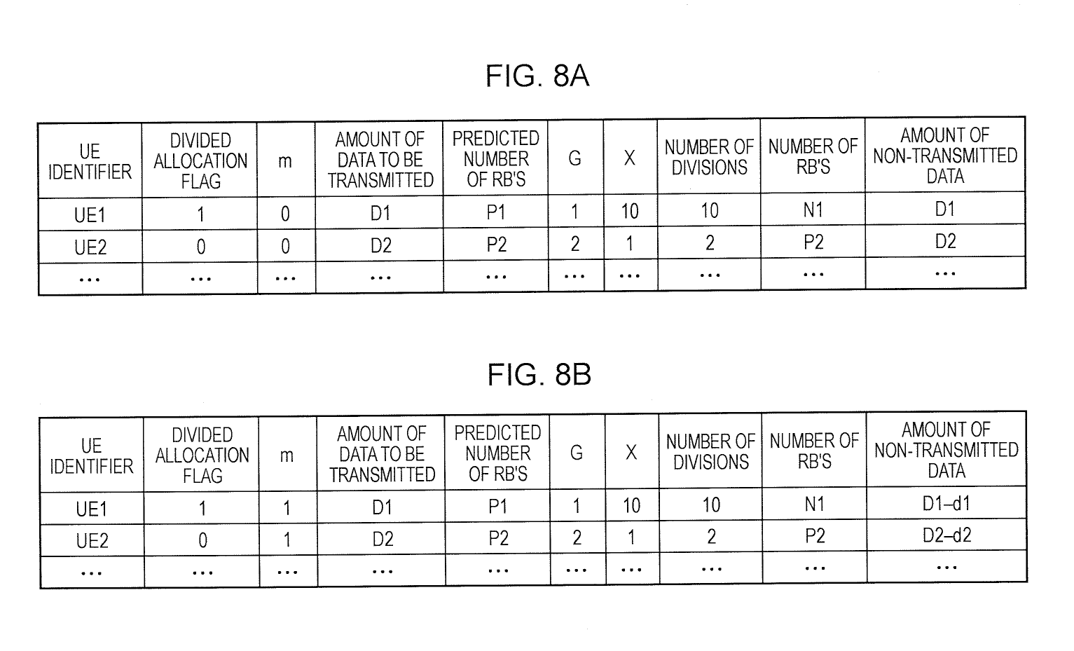

(5) When notified of the amount of data to be transmitted by UE1, the base station 10 executes a procedure described below to determine the number of communications carried out to transmit and receive the transmission data, based on the amount of data to be transmitted and the communication quality of the data received from UE1. Communication with UE1 will be described below by using an example in which the number of communications is determined as illustrated in FIG. 8A.

To obtain the predicted division count G, the dividing count predicting unit 41 first determines a modulation method, a coding rate, and a predicted number of allocatable resource blocks, based on the quality of communication between the terminal 1 and the base station 10. The dividing count predicting unit 41 may use, for example, a scheduling coefficient to determine an allocation order among a plurality of terminals. As a method of calculating the scheduling coefficient, a proportional fairness method, a round robin method, a maximum carrier-to-interference-and-noise ratio method (maximum CINR method), and any other methods may be used. It is assumed here that as a result of calculating a priority order, UE1 is determined to be a terminal to which to allocate resource blocks and that the predicted number of resource blocks to be allocated to UE1 (the predicated allocation count) is P1.

After having determined the predicated allocation count, the dividing count predicting unit 41 obtains a transport block size (TBS) by using the determined modulation method and the determined coding rate. The transport block size obtained by the dividing count predicting unit 41 is a value obtained from the predicted number of allocatable resource blocks. The value of the transport block size obtained by the dividing count predicting unit 41 will be referred to below as the predicted value of the transport block size. The dividing count predicting unit 41 uses an equation below to obtain the predicted division count from the predicted value of the transport block size. Since G in the equation is an integer, when the calculation result is not an integer, the fraction is rounded up.

G=D1/TBSp

where G is the predicted division count and TBSp is the predicted value of the transport block size. In the case, the obtained predicted division count G is assumed to be 1 as indicated on the row of UE1 in FIG. 8A.

The adjustment count calculating unit 42 calculates an adjustment count. It is assumed here that the adjustment count is the number of TPC commands used to adjust the SIR of a reception signal from the terminal 1 to the target SIR, and will be also denoted as TPC command count or TPC command count X. The adjustment count calculating unit 42 calculates the SIR by using the electric power of a reception signal from UE1. In the calculation of the SIR, the adjustment count calculating unit 42 uses the electric power of a signal received through the PUSCH. The adjustment count calculating unit 42 obtains a difference between an actually measured SIR value (SIR_obs) and the target SIR (SIR_t) and calculates the number of adjustments that are to be carried out to reduce the difference to zero.

$$\begin{matrix}\begin{matrix}X = ( SIR\_t - SIR\_obs ) / A \\ = dsir / A\end{matrix} & ( α )\end{matrix}$$

where X is the number of TPC commands, dsir is a difference between the actually measured SIR value and the target SIR, and A is a difference that is reduced in one adjustment. A is a non-0 value. Since X is an integer, when the calculation result of equation (α) is not an integer, the fraction is rounded up.

In this example, the adjustment count calculating unit 42 determines the amount A of adjustment, based on the table illustrated in FIG. 5. The adjustment count calculating unit 42 recognizes, from the table in FIG. 5, that when SIR_obs of electric power received from UE1 is smaller than target SIR SIR_t, the adjustment count calculating unit 42 is able to request UE1 to increase the transmission power by 3 dB or 1 dB. Similarly, when SIR_obs of electric power received from UE1 is larger than target SIR SIR_t, the adjustment count calculating unit 42 recognizes that the adjustment count calculating unit 42 is able to request UE1 to decrease the transmission power by 1 dB. The adjustment count calculating unit 42 also determines the amount of adjustment as described below according to the value of dsir:

when dsir≦−1, let A be −1, and the transmission power is decreased by 1 dB;

when −1<dsir<1, let A be 0, and no adjustment is made;

when 1≦dsir<3, let A be 1, and the transmission power is increased by 1 dB; and

when 3≦dsir, let A be 3, and the transmission power is increased by 3 dB.

In this case, when A is 0, the value of A is not applicable to equation (α). Therefore, when A is 0, the adjustment count calculating unit 42 sets X (the TPC command count) at 1.

For example, when the actually measured SIR value for UE1 is −10 dB and the target SIR is 20 dB, dsir is 30 dB. When a TPC command in FIG. 5 is used, it is possible to increase the transmission power of the terminal 1a by +3 dB in one adjustment. Therefore, the SIR is expected to be improved by +3 dB in one adjustment. Since X=30/3=10, the adjustment count calculating unit 42 obtains 10 as the TPC command count. The adjustment count calculating unit 42 then outputs the TPC command count to the dividing count determining unit 43. The adjustment count calculating unit 42 also outputs the amount A of adjustment to the DL signal processing unit 53.

The dividing count determining unit 43 compares the TPC command count and the predicted division count, and determines a division count (the number of divisions) from the comparison result. For UE1, the TPC command count is 10 and the predicted division count is 1. For UE1, therefore, the dividing count determining unit 43 sets the division count at 10 as illustrated in FIG. 8A. The description below assumes that to identify terminals for which the TPC command count is larger than the predicted division count, a divided allocation flag associated with a terminal identifier is used. For a terminal for which the TPC command count is larger than the predicted division count, the division count is made larger than the predicted division count to provide a chance to request transmission power adjustment, and the dividing count determining unit 43 sets the divided allocation flag at 1. Meanwhile, the divided allocation flag whose value is set at 0 indicates that the division count and predicted division count match.

The RB allocating unit 44 uses a value larger than a value obtained by dividing the amount of transmission data by the division count as the transport block size used to transmit transmission data. The transport block size calculated by the RB allocating unit 44 is a value determined to be used to transmit transmission data. Accordingly, the transport block size obtained by the RB allocating unit 44 will be also referred to as the determined transport block size. For example, since the division count for UE1 is X, a value that is equal to or more than D1/X and closest to D1/X is selected as the determined transport block size for UE1. Assume that the RB allocating unit 44 has set the amount of data transmitted from UE1 at one time, at d1, according to the determined transport block size. The RB allocating unit 44 further obtains the number of resource blocks to be allocated to UE1 by using the determined transport block size, the determined modulation method, and the determined coding rate. It is assumed here that N1 resource blocks have been allocated to UE1. In this case, information that the resource allocating unit 40 has obtained for UE1 becomes as indicated on the row of UE1 in FIG. 8A. In FIG. 8A, the variable m indicates the number of times the base station 10 has requested the terminal 1 to adjust transmission power. In this case, m is 0 since the base station 10 has not yet requested UE1 to adjust transmission power.

(6) The RB allocating unit 44 outputs information about the allocated resource block to the DL signal processing unit 53. In the information output to the DL signal processing unit 53, the division count used to transmit transmission data from UE1 is X and the number of resource blocks to be allocated to UE1 is N1. The DL signal processing unit 53 also notifies UE1 of information about the amount A of adjustment that has been notified from the adjustment count calculating unit 42. The DL signal processing unit 53 stores the amount A of adjustment in association with the identifier identifying the terminal 1. For example, the DL signal processing unit 53 stores the amount A of adjustment to be made by UE1 as +3 dB. The DL signal processing unit 53 may also store the value of the TPC command that has been notified to the terminal, in association with the identifier identifying the terminal. For example, the DL signal processing unit 53 may store the TPC command as information indicating “UE1=+3”.

The DL signal processing unit 53 creates a control signal, destined for UE1, that includes the obtained information. The information created by the DL signal processing unit 53 is processed by the coding unit 52, modulating unit 51, and RF processing unit 12 in that order, after which the processed information is transmitted to UE1.

When the terminal 1 is notified of the resource block allocation, UE1 is requested to adjust its transmission power. The RB allocating unit 44 notifies UE1 of resource block allocation and then increments the variable m for UE1 by one, thereby m being set at 1.

(7) When notified, from the base station 10, of the resource block allocation and the amount of transmission power to be adjusted (the amount of adjustment), UE1 adjusts its transmission power according to the notified amount of adjustment. For UE1, for example, the amount A of adjustment is 3 dB, so UE1 increases its transmission power by 3 dB.

(8) After adjusting the transmission power of UE1, UE1 transmits a frame in which part of the transmission data using the resource block notified from the base station 10. The retransmission deciding unit 45 of the base station 10 checks for an error based on the CRC included in the received frame. When an error is found in the received frame, the retransmission deciding unit 45 requests retransmission. It is assumed here that there is no error in the frame received from UE1. In this case, since data d1 has been transmitted in successful data transmission, the amount of non-transmitted data becomes D1−d1. Further, information on UE1 is changed as illustrated in FIG. 8B.

(9) Since there exist transmission data whose amount is equal to D1−d1 left in UE1, the RB allocating unit 44 of the base station 10 allocates resource blocks. In this case, the RB allocating unit 44 refers to the information illustrated in FIG. 8B, and check whether the value of the variable m is smaller than X, that is, the TPC command count. When the value of the variable m is smaller than X (the TPC command count), this indicates that transmission power adjustment by UE1 has not been completed. In this case, since the value of the variable m is 1, that is, m (=1) is smaller than X (=10), the RB allocating unit 44 determines that transmission power adjustment by UE1 has not been completed. Therefore, the RB allocating unit 44 allocates resource blocks to UE1 under the conditions set in step (5). That it, the RB allocating unit 44 determines to allocate N1 resource blocks to UE1. After having allocated the resource blocks, the RB allocating unit 44 notifies the DL signal processing unit 53 of an allocation result in association with the identifier identifying UE1.

Upon receipt of a notification of the resource allocation result from the RB allocating unit 44, the DL signal processing unit 53 identifies the amount of transmission power adjustment that is associated with the terminal identifier that has been notified together with the resource allocation result. The DL signal processing unit 53 then creates a control signal that includes resource block allocation and the amount of transmission power adjustment to be made by UE1. The created control signal is processed by the coding unit 52, modulating unit 51, and RF processing unit 12 in that order, after which the processed signal is transmitted to UE1.

(10) Upon receipt of the notification of the resource block allocation and the amount of transmission power adjustment to be made, from the base station 10, UE1 adjusts the transmission power thereof in a manner similar to step (7).

(11) After adjusting the transmission power, UE1 transmits a frame containing part of the transmission data to the base station 10. Then, the base station 10 performs processing in a manner similar to step (8).

(12) After that, the processing in steps (9) to (11) is repeated. In this processing, the RB allocating unit 44 does not check whether the data is retransmission data or not, when allocating resource blocks. Therefore, even if UE1 requests the RB allocating unit 44 to allocate resource blocks used for transmission of retransmission data, the RB allocating unit 44 allocates N1 resource blocks to UE1 when the value of the variable m is less than X. In addition, the DL signal processing unit 53 creates a resource block allocation notification that includes the amount of transmission power adjustment associated with UE1.

In the case, it is assumed that the base station 10 has requested UE1 to adjust the transmission power thereof as many times as the TPC command count (X times) by repeating the processing in steps (9) to (11). When there exist transmission data left in UE1, the adjustment count calculating unit 42 obtains the SIR for UE1 by using the last data received from UE1, and compares the obtained SIR with the target SIR.

When the SIR of UE1 is within a range in which the SIR is changeable to the target SIR in one adjustment, the adjustment count calculating unit 42 changes the value of X to 1 and output the changed value to the dividing count determining unit 43. The adjustment count calculating unit 42 further obtains the amount of transmission power adjustment to be made by UE1 again and outputs the obtained value to the DL signal processing unit 53.

(13) The dividing count determining unit 43 determines that a request for UE1 to change transmission power is unnecessary when notifying UE1 of resource blocks for transmissions of next and later transmission data. Then, the RB allocating unit 44 restores the number of resource blocks to be allocated to UE1 to the predicated allocation count P1. The RB allocating unit 44 allocates resource blocks and outputs an allocation result to the DL signal processing unit 53.

(14) The DL signal processing unit 53 creates a control signal that includes the allocation result received from the RB allocating unit 44 and the amount of transmission power adjustment received from the adjustment count calculating unit 42. The created control signal is transmitted to UE1.

(15) UE1 adjusts the transmission power thereof in a manner similar to steps (7) and (10).

(16) Upon completion of transmission power adjustment, UE1 transmits transmission data to the base station 10. The retransmission deciding unit 45 of the base station 10 receives the transmission data and determines whether there exists an error in the received transmission data. It is assumed here that the base station 10 has received the transmission data correctly.

(17) When the base station 10 determines that all the transmission data has been successfully received from UE1, the base station 10 terminates communication with UE1.

When control of retransmission has not been performed between UE1 and the base station 10, the division count for UE1 has been set at X, and transmission of all the transmission data has been completed by transmitting a frame X times. Accordingly, when there has been no retransmission, the processing in steps (12) to (16) is not performed.

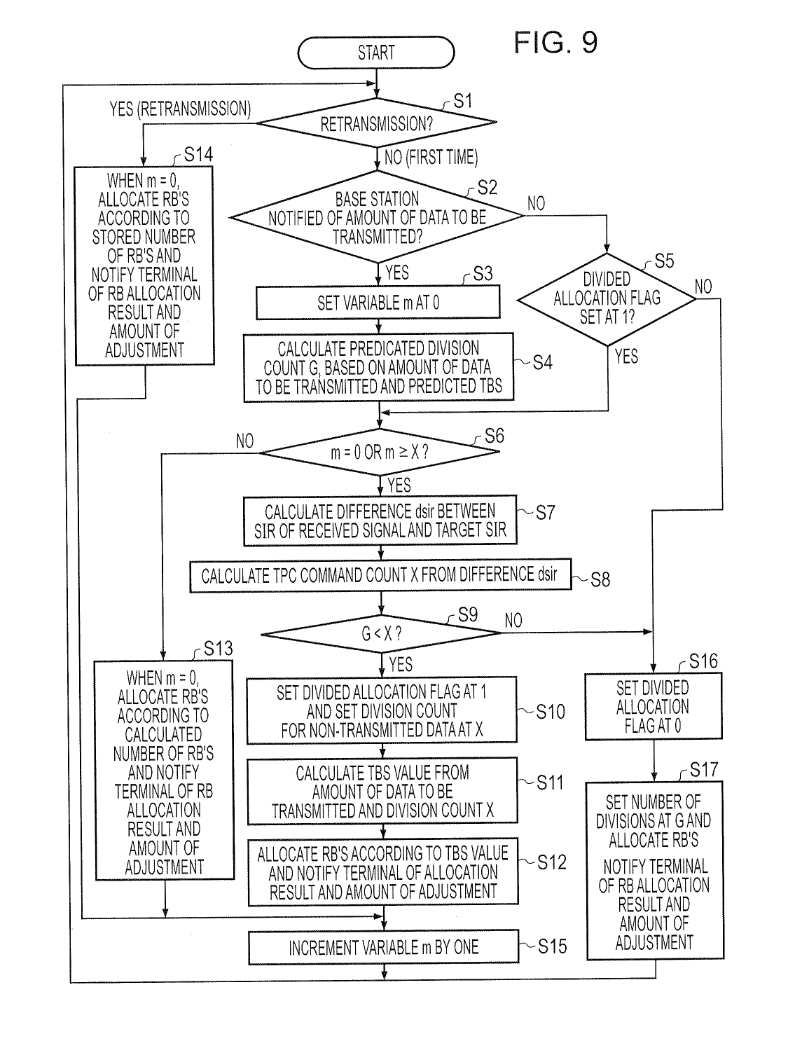

FIG. 9 is a diagram illustrating an example of an operational flowchart of a base station, according to a first embodiment. Upon receiving a communication request from the terminal 1, the retransmission deciding unit 45 determines whether data to be transmitted is retransmission data or not based on the status of error occurrences in the previous reception data (step S1). When data to be transmitted is not retransmission data (the result in step S1 is No (first time)), the dividing count predicting unit 41 determines whether the base station 10 has been notified of the amount of transmission data from the terminal 1 (step S2). When the base station 10 has been notified of the amount of transmission data from the terminal 1 (the result in step S2 is Yes), the dividing count predicting unit 41 sets the variable m at 0 (step S3). Then, the dividing count predicting unit 41 obtains the predicted division count G based on the amount of transmission data and a predicted value of the transport block size (TBS) (step S4). Meanwhile, when the base station 10 has not been notified of the amount of transmission data (the result in step S2 is No), there is a possibility that resource blocks will be allocated under the already determined conditions so as to allow the terminal 1 to transmit next data subsequent to the already received data. Therefore, the RB allocating unit 44 determines whether the divided allocation flag is set at 1 or not (step S5).

When the processing of step S4 has been performed or it is determined that the divided allocation flag is set at 1 in step S5, there is a possibility that the number of divisions will be determined.

First, a case in which the sequence proceeds from step S4 to step S6 will be described. The adjustment count calculating unit 42 determines whether the value of the variable m is 0 (step S6). When the sequence proceeds from step S4 to step S6, the value of m is 0 (the result in step S6 is Yes), and the adjustment count calculating unit 42 obtains a difference (dsir) between the SIR (SIR_obs) of the received signal from the terminal 1 and the target SIR (SIR_t) (step S7). The adjustment count calculating unit 42 then calculates, from dsir and A indicating the amount of transmission power adjustment, TPC command count X indicating the number of TPC commands to be transmitted to the terminal 1 (step S8).

The dividing count determining unit 43 determines whether the predicted division count G is smaller than the TPC command count X indicating the number of TPC commands to be transmitted (step S9). When the predicted division count G is smaller than the TPC command count X (the result in step S9 is Yes), the dividing count determining unit 43 makes the division count larger than the predicted division count. Thus, the dividing count determining unit 43 sets the divided allocation flag at 1 and also sets the division count at X (step S10). The RB allocating unit 44 then calculates a transport block size (TBS), based on the amount of data to be transmitted and the division count X (step S11). The RB allocating unit 44 allocates resource blocks by using the calculated transport block size, and notifies the terminal 1 of the allocation result together with a request for transmission power adjustment (step S12).

When the value of the divided allocation flag is determined to be 1 in step S5, there is also a possibility that a division count is determined. When any frame including transmission data is retransmitted, the transmission power of UE1 may be adjusted during the retransmission as well. In this case, the variable m is being set at the value equal to the TPC command count X or more. Accordingly, when the value of m is not 0, the adjustment count calculating unit 42 determines whether the condition that the value of m is X or more is met (step S6). When the value of the variable m is X or more, there is a possibility that UE1 has terminated transmission power adjustment. Therefore, when the value of m is equal to or greater than the TPC command count X determined for the terminal 1 (the result in step S6 is Yes), the adjustment count calculating unit 42 determines whether to further request UE1 to adjust the transmission power thereof as indicated in steps S7 to S12. When the TPC command count X recalculated in step S8 is larger than the predicted division count G (the result in step S9 is Yes), the base station 10 determines that transmission power adjustment by UE1 is inadequate and continues processing to request UE1 to adjusts its transmission power by executing steps that are followed when the result in step S9 is Yes.

When the result in step S6 is No, the dividing count determining unit 43 determines that resource blocks are to be allocated according to the already calculated number of resource blocks or the already calculated determined transport block size. Thus, the RB allocating unit 44 allocates resource blocks to the terminal 1 according to the already calculated transport block size. In addition, the base station 10 notifies the terminal 1 of an allocation result together with a transmission power adjustment request (step S13).

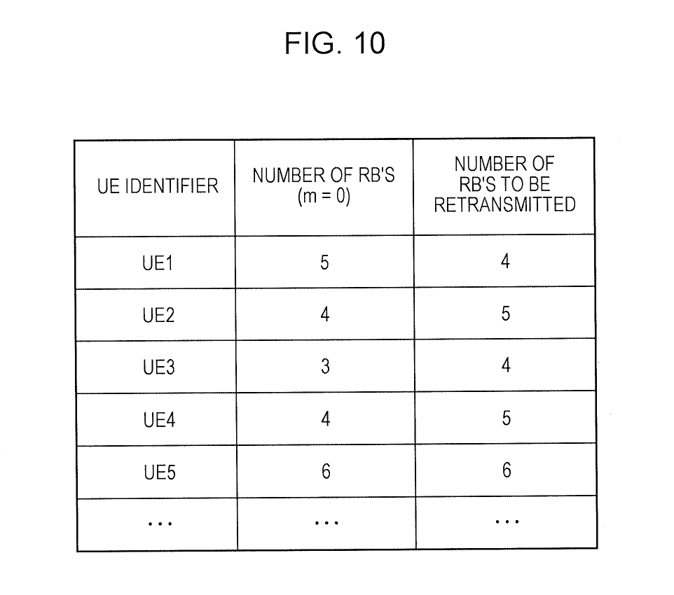

When data to be transmitted is determined to be retransmission data in step S1, the RB allocating unit 44 allocates resource blocks to the terminal 1 according to the already calculated number of resource blocks. FIG. 10 is a diagram illustrating an example of a table held by a RB allocating unit, according to an embodiment. The RB allocating unit 44 holds the number of resource blocks allocated to each terminal 1 until the retransmission deciding unit 45 determines that the transmitted data includes no error. When resource block allocation is requested for retransmission to a terminal 1 for which an error has been detected, the RB allocating unit 44 allocates resource blocks according to the held value and requests UE1 to adjust the transmission power thereof (step S14).

When processing in any one of steps S12 to S14 is completed, the RB allocating unit 44 increments the variable m by one (step S15). After that, the processing of step S2 and later is repeated each time the resource block allocation is requested from the terminal 1.

When the result in step S5 or step S9 is No, the dividing count determining unit 43 sets the divided allocation flag at 0 (step S16). The dividing count determining unit 43 then changes the value of the division count to the predicted division count G calculated in step S4. The RB allocating unit 44 allocates resource blocks according to the predicated number P1 of resource blocks to be allocated (step S17). The base station 10 notifies the terminal 1 of a resource block allocation result.

That is, when a difference between the SIR of a signal received after transmission power adjustment by the terminal 1 and the target SIR is small, the dividing count determining unit 43 determines that it is unnecessary to acquire a chance to request the terminal 1 to adjust its transmission power by forcibly dividing the transmission data. In the case, when a difference between the SIR of the received signal and the target SIR is small, the difference is expected to vanish in one transmission power adjustment by the terminal 1. It may also be said that the dividing count determining unit 43 has determined that the predicted number of resource blocks (the predicated allocation count) obtained for terminal 1 is to be used for bandwidth allocation to the terminal 1.

Also in the case where a difference between an actually measured SIR value and the target SIR is small before the transmission power is adjusted, the predicated allocation count is used for resource block allocation to the terminal 1. For example, as illustrated in FIGS. 8A and 8B, the predicted division count G is larger than the TPC command count X for UE2. In this case, the dividing count determining unit 43 sets the division count at the predicted division count and sets the divided allocation flag at 0. Also after the processing in step S17 has been completed, the processing subsequent to step S2 is repeated each time resource block allocation is requested from the terminal 1.

As described above, in the first embodiment, when the number of times the terminal 1 is to be requested to adjust its transmission power exceeds the predicted division count, which is predicted from the amount of transmission data to be transmitted from the terminal 1, the base station 10 changes the division count so as to conform with the number of times transmission power adjustment is requested for the terminal 1. Therefore, even if a terminal 1 transmits only a small amount of transmission data and has an inadequate value of transmission power, the base station 10 is able to cause the terminal 1 to perform transmission power adjustment. As a result, transmission power used by the terminal 1 to transmit data in the subsequent communications is highly likely to have been set at a value allowing the base station 10 to obtain the target SIR.

In addition, the base station 10 uses the variable m to count the number of times the base station 10 has requested the terminal 1 to adjust its transmission power. When the base station 10 has requested the terminal 1 to adjust its transmission power as many times as the number of times obtained from reception quality, the base station 10 determines whether the transmission power adjustment has been completed by checking the reception quality of UE1. When the transmission power adjustment has been completed, the base station 10 no longer requests the terminal 1 to adjust its transmission power. For example, in step S17, the base station 10 transmits, to terminal 1, a resource block allocation notification including the amount A of transmission power adjustment that is set at 0. Thus, the base station 10 is operable to check whether transmission power adjustment by the terminal 1 is adequate each time the terminal 1 has completed a predetermined number of transmission power adjustments. This also suppresses the quality of data reception from the terminal 1, from being deteriorated, which would otherwise be caused by excessive adjustment due to too many adjustment requests for the terminal 1.

### Second Embodiment

In a second embodiment, a base station 10 will be described that requests the terminal 1 to adjust its transmission power as many times as an SIR adjustment count Y, which is smaller than or equal to a maximum division value Dmax, when the TPC command count X becomes a very large value.

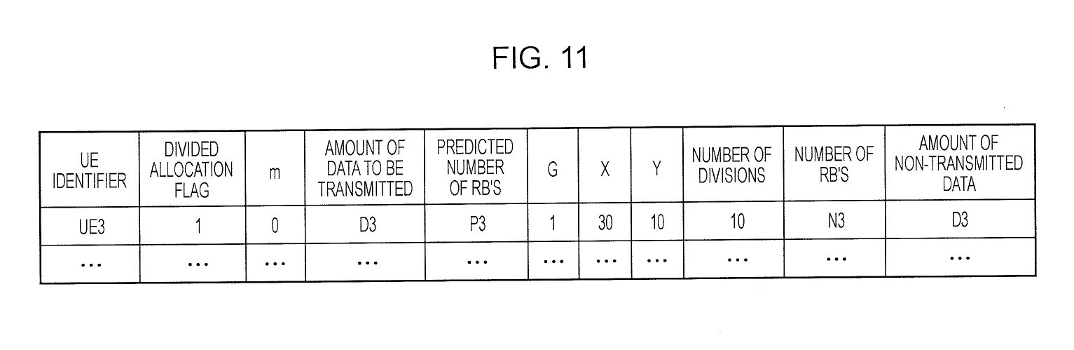

FIG. 11 illustrates an example of information that is used, by the base station 10 operated using a method according to the second embodiment, to allocate resource blocks. Elements included in the information illustrated in FIG. 11 may be the same as those in FIG. 8A except that the SIR adjustment count Y is included. Since the TPC command count X is obtained based on the actually measured SIR value of a signal transmitted from the terminal 1, it may be said that the X is easily affected by the status of a propagation path between the terminal 1 and the base station 10. For example, assume that the status of the propagation path between the terminal 1 and the base station 10 is temporarily worsened and thereafter restored. In this case, if transmission power is adjusted by the number of times that was set at the time when the status of the propagation path was worsened, the transmission power may be inadequately adjusted. To solve this problem, when the TPC command count X exceeds the maximum division value Dmax, the dividing count determining unit 43 limits the number of divided pieces of transmission data to the SIR adjustment count Y which is smaller than or equal to the maximum division value Dmax. In this case, transmission data may be left in a terminal 1 even after as many adjustments as the SIR adjustment count Y have been made. Then the base station 10 sets the number of transmission power adjustments again for the terminal 1.

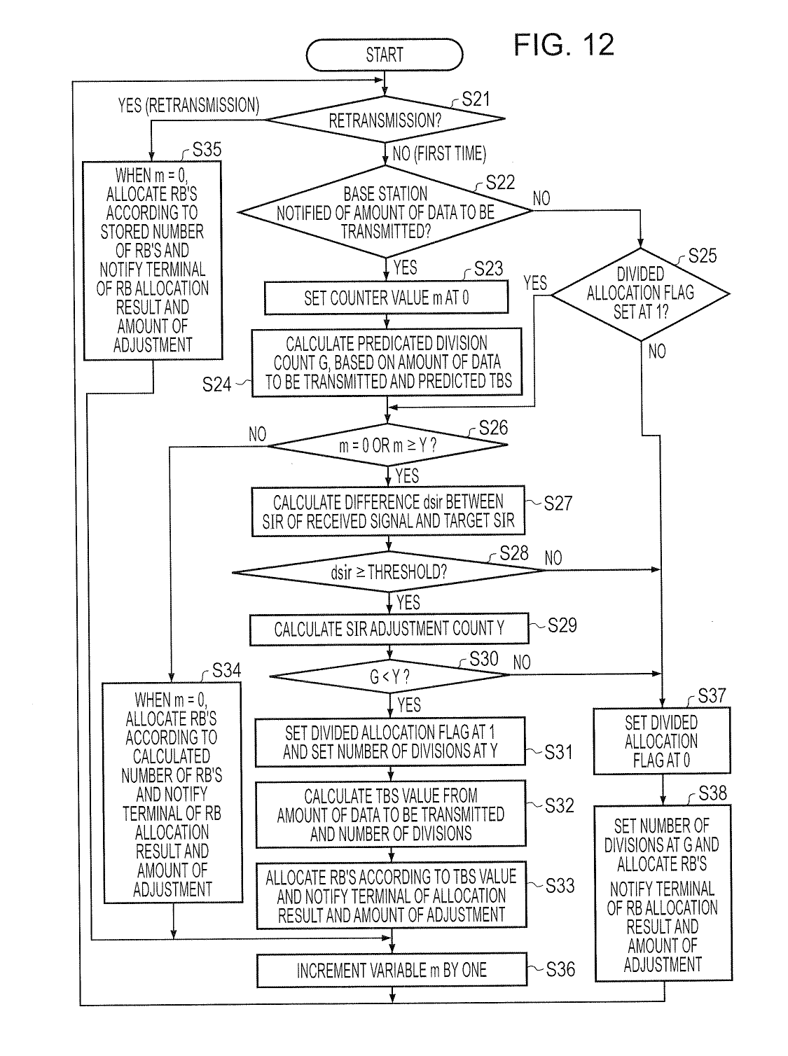

FIG. 12 is a flowchart illustrating an example of the operation of the base station 10 in the second embodiment. Operations performed when UE3 transmits a communication request to the base station 10 will be described with reference to FIG. 12. Steps S21 to S25 are the same as steps S1 to S5 that have been described with reference to FIG. 9. That is, when UE3 notifies the base station 10 of the amount D3 of transmission data in a first data transmission, the predicted division count G is calculated based on a predicted number of resource blocks to be allocated and the predicted value of the transport block size. The predicted division count for UE3 is 1, as illustrated in FIG. 11.

The adjustment count calculating unit 42 determines whether the terminal 1 meets the condition that the value of the variable m is 0 or is larger than or equal to the SIR adjustment count Y (step S26). Here, the case where the value of m is larger than or equal to the SIR adjustment count Y implies the fact that after the transmission power of UE3 had been adjusted as many times as the SIR adjustment count Y, the terminal 1 has requested allocation of resource blocks used to transmit transmission data. When the value of m is 0 or is larger than or equal to the SIR adjustment count Y (the result in step S26 is Yes), the adjustment count calculating unit 42 obtains the difference (dsir) between the SIR (SIR_obs) of the reception signal from the terminal 1 and the target SIR (SIR_t) (step S27). The adjustment count calculating unit 42 further determines whether the difference dsir is larger than or equal to a threshold. When the difference dsir is larger than or equal to the threshold (the result in step S28 is Yes), the adjustment count calculating unit 42 calculates the SIR adjustment count Y from the amount A of adjustment (step S29). Meanwhile, for example, when the threshold is +3 dB and the difference dsir is smaller than +3 dB, the adjustment count calculating unit 42 does not calculate the number of adjustments. In the example in FIG. 12, although only one threshold is used, the adjustment count calculating unit 42 may be configured to determine whether the difference dsir falls within a range between two thresholds. For example, when the difference dsir is at least −2 dB and at most +3 dB, the adjustment count calculating unit 42 may not calculate the SIR adjustment count Y. The threshold used in step S28 may be set at any value according to the mounting state. A method of calculating the SIR adjustment count Y will be described later.

The dividing count determining unit 43 determines whether the predicted division count G is smaller than the SIR adjustment count Y (step S30). When the predicted division count G is smaller than the SIR adjustment count Y (the result in step S30 is Yes), the dividing count determining unit 43 makes the division count larger than the predicted division count G. That is, the dividing count determining unit 43 sets the divided allocation flag at 1 and further sets the division count at the SIR adjustment count Y (step S31). For example, for UE3 in FIG. 11, since the predicted division count G is 1 but the SIR adjustment count Y is 10, the dividing count determining unit 43 sets the division count at 10. Processing in steps S32 to S38 in FIG. 12 is similar to the processing in steps S11 to S17 which has been described with reference to FIG. 9.

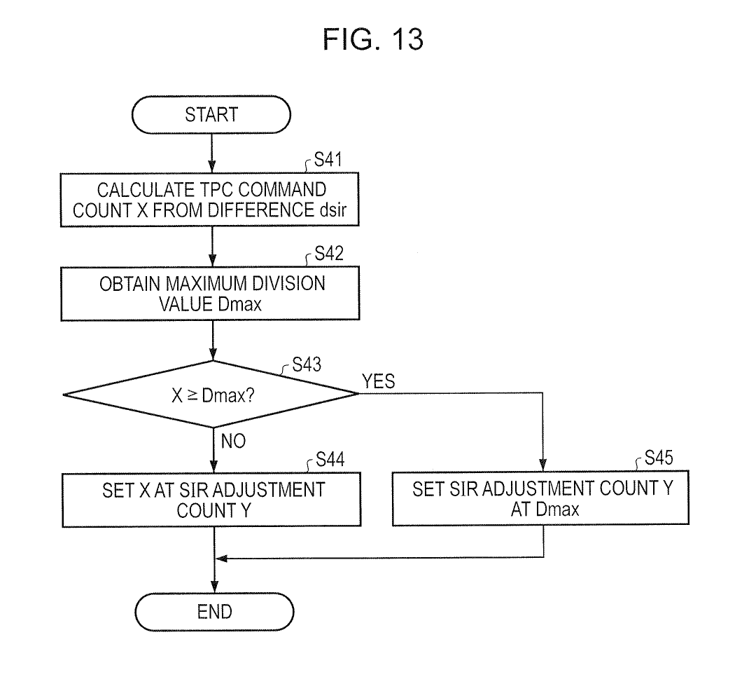

FIG. 13 is a flowchart illustrating an example of a method of calculating the number of SIR adjustments, according to an embodiment. The adjustment count calculating unit 42 first obtains a TPC command count X from the difference dsir and the amount A of adjustment (step S41). The adjustment count calculating unit 42 then obtains the maximum division value Dmax (step S42). The maximum division value Dmax is assumed to have been stored in the memory 63 in advance. The adjustment count calculating unit 42 determines whether the TPC command count X is greater than or equal to the maximum division value Dmax (step S43). When the TPC command count X is smaller than the maximum division value Dmax (the result in step S43 is No), the adjustment count calculating unit 42 sets the TPC command count X at the SIR adjustment count Y (step S44). Meanwhile, when the TPC command count X is larger than or equal to the maximum division value Dmax (the result in step S43 is Yes), the adjustment count calculating unit 42 sets the SIR adjustment count Y at the maximum division value Dmax (step S45). For example, for UE3 in FIG. 11, since the TPC command count X is 30 but the maximum division value Dmax is 10, the adjustment count calculating unit 42 sets the SIR adjustment count Y at a value equal to the maximum division value Dmax as illustrated in FIG. 11.

As described above, obtaining the SIR adjustment count Y lessens adverse effects due to changes in the situation of the propagation path. Furthermore, as in the first embodiment, transmission power is appropriately controlled even for a terminal 1 that transmits a relatively small amount of transmission data.

Others

Embodiments are not limited to the examples described above. Various variations are possible. Examples of some variations will be described below.

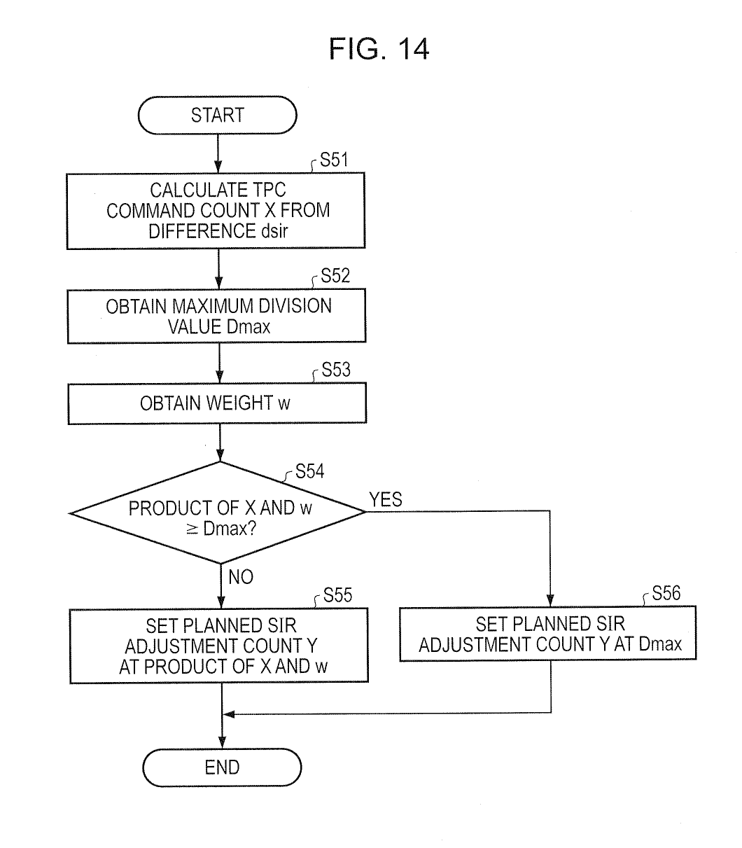

FIG. 14 is a flowchart illustrating an example of another method of calculating the number of SIR adjustments. A variation of the second embodiment will be described with reference to FIG. 14. In the method illustrated in FIG. 14, a weight w is further used.

Processing in steps S51 to S52 in FIG. 14 is similar to the processing in steps S41 to S42 which have been described with reference to FIG. 13. After these steps, the adjustment count calculating unit 42 obtains the weight w from the memory 63 (step S53). The weight w is assumed to be a positive value smaller than or equal to 1 and vary according to the value of the TPC command count X. For example, the adjustment count calculating unit 42 is configured to store the weight w so that its value is reduced as the TPC command count is increased, as described below:

when 1≦X<10, w=1;

when 10≦X<15, w=0.9; and

when 15≦X<20, w=0.7.

The adjustment count calculating unit 42 compares the maximum division value Dmax with the product of the TPC command count X and the weight w (step S54). When the product of the TPC command count X and the weight w is smaller than the maximum division value Dmax (the result in step S54 is No), the adjustment count calculating unit 42 sets the SIR adjustment count Y at the product of the TPC command count X and the weight w (step S55). When the product of the TPC command count X and the weight w is not an integer, the adjustment count calculating unit 42 rounds up the fraction and sets the SIR adjustment count Y at the resulting value. When the product of the TPC command count X and the weight w is larger than or equal to the maximum division value Dmax (the result in step S54 is Yes), the adjustment count calculating unit 42 sets the SIR adjustment count Y at the maximum division value Dmax (step S56). The SIR adjustment count Y obtained in FIG. 14 is used in the processing that has been described with reference to FIG. 12.

When the weight w is used as illustrated in FIG. 14, it becomes possible to further lessen adverse effects due to variations in the value of the difference dsir caused by changes in the situation of the propagation path.

Although FIG. 4 illustrates an example of channels used in a system that conforms to the Long Term Evolution (LTE) standard, the base station 10 may be also used in a system that conforms to another communication standard such as LTE-Advanced.

The tables used in the descriptions above are also only examples. The information items included in the tables may be sometimes changed according to the mounting state. The values used in the descriptions above are also only examples.

It is also possible to change the processing in the flowchart in FIG. 9 so that after the processing in step S13, the adjustment count calculating unit 42 obtains the difference dsir between the current SIR and the target SIR and determines whether the difference dsir will be vanished by one more transmission power adjustment by the terminal 1. In this case, when the adjustment count calculating unit 42 determines that the difference dsir will be vanished by a next transmission power adjustment, the dividing count determining unit 43 changes the value of the divided allocation flag associated with the terminal 1 to 0. After the divided allocation flag has been set at 0, the RB allocating unit 44 allocates resource blocks to the terminal 1 according to the predicted number of resource blocks to be allocated.

It is also possible to change the processing in the flowchart in FIG. 12 so that each time the processing in step S34 is finished, the adjustment count calculating unit 42 obtains the difference dsir and the dividing count determining unit 43 determines whether to continue processing for dividing the resource blocks to be allocated to the terminal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus for adjusting transmission power of a terminal wirelessly communicating with the apparatus, the apparatus comprising:
a radio frequency (RF) processing circuit configured to receive, from the terminal, a communication request that includes a data amount value indicating an amount of transmission data held in the terminal;
a control circuit configured:
to obtain a predicted division count indicating a predicted number of frames to be used for transmitting the transmission data, based on the data amount value and a first bandwidth value indicating a predicted amount of bandwidth allocatable to the terminal,
to obtain a first difference between a target value of reception quality of data to be received from the terminal and a measured value of reception quality of data that has been actually received from the terminal,
to calculate an adjustment count value indicating a number of times the terminal is to be requested to adjust transmission power until the first difference falls to or below a threshold value, and
to reduce an second bandwidth value indicating an amount of bandwidth to be actually allocated to the terminal when the predicted division count is smaller than the adjustment count value, so that the transmission data is transmitted by using as many frames as the adjustment count value; and
a memory configured to store data used for processing performed by the control circuit, wherein
the RF processing circuit transmits, to the terminal, an adjustment request for adjusting the transmission power of the terminal, together with the second bandwidth value, before the terminal transmits each of frames used for transmitting the transmission data.

2. The apparatus of claim 1, wherein
when a second difference between the target value and the measured value of reception quality of a signal transmitted from the terminal after the transmission power has been adjusted by the terminal is smaller than or equal to the threshold value, the control circuit determines to allocate a bandwidth of the first bandwidth value to the terminal; and
when it is determined that a bandwidth of the first bandwidth value is to be allocated to the terminal, the control circuit adjusts allocation of bandwidth according to the first bandwidth value.

3. The apparatus of claim 1, wherein
the control circuit stores a maximum value for the adjustment count value;
when the adjustment count value exceeds the maximum value, the control circuit sets the maximum value as a number of times the terminal is to be requested to adjust transmission power;
the control circuit adjusts an amount of bandwidth to be allocated to the terminal so that the transmission data is transmitted with as many frames as the maximum value; and
the RF processing circuit transmits, to the terminal, the adjustment request for adjusting the transmission power, as many times as the maximum value.

4. A method for adjusting transmission power of a terminal wirelessly communicating with a base station, the method comprising:
receiving, by the base station, from the terminal, a communication request that includes a data amount value indicating an amount of transmission data held in the terminal;
obtaining, by the base station, a predicted division count indicating a predicted number of frames to be used for transmitting the transmission data, from the data amount value and a first bandwidth value indicating a predicted amount of bandwidth allocatable to the terminal;
obtaining, by the base station, a first difference between a target value of reception quality of data to be received from the terminal and a measured value of reception quality of data that has been actually received from the terminal;
calculating, by the base station, an adjustment count value indicating a number of times the terminal is to be requested to adjust transmission power until the first difference falls to or below a threshold value;
reducing, by the base station, when the predicted division count is smaller than the adjustment count value, an second bandwidth value indicating an amount of bandwidth to be actually allocated to the terminal so that the transmission data is transmitted by using as many frames as the adjustment count value; and
transmitting, by the base station, to the terminal, an adjustment request for adjusting the transmission power of the terminal, together with the second bandwidth value, before the terminal transmits each of frames used for transmitting the transmission data.

5. The method of claim 4, further comprising:
receiving, by the terminal, from the base station, the adjustment request for adjusting the transmission power, as many times as the adjustment count value when the base station reduces the second bandwidth value so that the transmission data is transmitted by using as many frames as the adjustment count value; and
adjusting, by the terminal, the transmission power of the terminal as many times as the adjustment count value, by repeating an adjustment process including:
receiving the adjustment request from the base station,
changing the transmission power of the terminal by an amount of adjustment indicated by the received adjustment request, and
transmitting a frame including a part of the transmission data to the base station.
